(19) United States
(12) Patent Application Publication
(10) Pub. No.: US 2022/0120628 A1
(43) Pub. Date: Apr. 21, 2022

(54) SENSOR CIRCUIT INTEGRATING STANDARD CMOS SENSORS WITH ENERGY EFFICIENCY AND SENSOR APPARATUS HAVING SAME

(71) Applicant: KOREA ADVANCED INSTITUTE OF SCIENCE AND TECHNOLOGY, Daejeon (KR)

(72) Inventors: Seong Hwan CHO, Daejeon (KR); Su Jin PARK, Daejeon (KR)

(21) Appl. No.: 17/434,560

(22) PCT Filed: Jun. 12, 2019
(86) PCT No.: PCT/KR2019/007063

§ 371 Date: Aug. 27, 2021

(30) Foreign Application Priority Data
Feb. 27, 2019 (KR) 10-2019-0023057

(51) Int. Cl. G01L 9/12; G01P 15/125; G01N 27/22

(52) U.S. Cl. CPC G01L 9/125; G01N 27/225; G01P 15/125

(57) ABSTRACT

Disclosed are an environment information sensor circuit and an environment information measurement device which can sense various kinds of environment information, such as pressure, humidity, acceleration and the like, and simply reduce quantization noise by employing a dual quantization capacitance-to-digital converter structure. The environment information sensor circuit comprises: a switch capacitor that outputs one among pressure information, humidity information, and acceleration information on the basis of a first clock signal and a second clock signal that do not overlap; a single-bit first order delta-sigma converter that includes an integrator which integrates the output from the switch capacitor and outputs the integrated output as an analog value, and a single-bit quantizer which compares the output from the integrator and a preset threshold voltage and outputs a single-bit digital signal corresponding to a comparison result; and a multi-bit quantizer that is connected to an output end of the integrator via a sampling switch, and quantizes the output from the integrator at the moment the sampling switch is turned on according to a sampling signal.

### TECHNICAL FIELD

The present invention relates to a sensor circuit and a sensor apparatus having the same, and more particularly, to a sensor circuit defining, integrating and reading a plurality of standard CMOS sensors, such as pressure sensors, humidity sensors, and acceleration sensors, as a sensor circuit which can sense environment information of a circuit block mounted in a semiconductor memory device and a sensor apparatus having the same.

### BACKGROUND ART

In general, with high performance of electronic systems, such as personal computers or electronic communication devices, various electronic semiconductor devices including DRAMs and volatile semiconductor memories are on the trends of high-speed and high-density integration.

Especially, because the semiconductor memory devices require low-power consumption characteristics, operating conditions of a circuit block are controlled in order to reduce operational current and standby current. In order to control the operating conditions, an environment information measuring device senses environment information of a circuit, controls an operational state according to the sensed environment information or monitors surrounding environment information in a normal operational state.

For instance, a refresh cycle of a DRAM cell is controlled according to retention time to respond to changes in environment information. Therefore, an environment information sensor circuit which can exactly sense changes in environment information must be essentially designed.

Meanwhile, in order to design such an environment information sensor circuit, lots of environment information sensor related technologies using complementary metal oxide semiconductors (CMOSs) have been proposed.

However, most of the proposed CMOS environment information sensors have several disadvantages in that they are inaccurate since there is an error in element resistance used in a circuit and dielectric permittivity of a capacitor, and in that it is difficult to obtain output resolution and accuracy required by a system in comparison with energy efficiency due to systemic noise generated by quantization sequence in digital conversion output.

Furthermore, such disadvantages are applied equally to sensors used in all kinds of smart devices, such as smart phones or smart bands, embodied by internet of things (IoT).

The smart phone uses sensors of ten or more kinds, such as an acceleration sensor, a temperature sensor, a pressure sensor, an image sensor and so on, and a smart vehicle uses about 200 sensors. As described above, because sensors are applied to most devices as key components, strengthening of competitiveness in the sensor industry is the necessity for strengthening national industrial competitiveness.

With such industrial necessity, development of an on-chip system with low-cost and high-performance for measuring various environment variables to mass-produce sensors is required, but integration technology for generally satisfying the requirement is not proposed clearly yet.

### DISCLOSURE

### Technical Problem

Accordingly, the present invention has been made in an effort to solve the above-mentioned problems occurring in the prior arts, and it is an object of the present invention to provide a sensor circuit and a sensor apparatus, which can sense various environment information, such as pressure, humidity, acceleration and so on, more accurately by adopting a dual quantization capacitance digital converter structure and can simply reduce quantization noise.

It is another object of the present invention is to provide a sensor circuit integrating standard CMOS sensors with energy efficiency and a sensor apparatus having the same, which can facilitate development of a sensor system-on-chip (SoC) with low-cost and high-performance for measuring various environment variables using the paradigm of a standard CMOS sensor.

### Technical Solution

To achieve the above objects, the present invention provides an environment information sensor circuit, which has one or more of pressure information, humidity information, and acceleration information, including: a switch capacitor that outputs at least one among pressure information, humidity information, and acceleration information on the basis of a first clock signal and a second clock signal that do not overlap; a single-bit 1st delta-sigma converter that includes an integrator which integrates output of the switch capacitor and outputs the integrated output as an analog value, and a single-bit quantizer which compares the output of the integrator and a preset threshold voltage with each other and outputs a single-bit digital signal corresponding to a compared result; and a multi-bit quantizer that is connected to an output terminal of the integrator by the medium of a sampling switch, and quantizes the output of the integrator at the moment the sampling switch is turned on according to a sampling signal.

Moreover, the switch capacitor includes: a sensor capacitor of which one end is connected to a node, wherein a first switch has one end connected to a power terminal and is turned on/off by the second clock signal, a second switch has one end connected to a ground terminal and is turned on/off by the first clock signal and the other end of the first switch and the other end of the second switch are connected to the node; a reference voltage providing capacitor of which one end is connected to a node, wherein a third switch has one end connected to a power terminal and is turned on/off by the second clock signal, a fourth switch has one end connected to a ground terminal and is turned on/off by the first clock signal and the other end of the third switch and the other end of the fourth switch are connected to the node; a charge providing capacitor of which one end is connected to a node, wherein a fifth switch has one end connected to a power terminal and is turned on/off by the second clock signal, a sixth switch has one end connected to a ground terminal and is turned on/off by the first clock signal and the other end of the fifth switch and the other end of the sixth switch are connected to the node; and a seventh switch mounted between the other end of the charge providing capacitor and the output terminal and turned on/off based on a single-bit digital signal getting feedback from the single-bit 1^{st} delta-sigma converter.

Furthermore, the charge providing capacitor unit which includes the charge providing capacitor and the seventh switch is connected in parallel with the sensor capacitor and the reference voltage providing capacitor.

Additionally, the single-bit digital signal is converted into an analog signal and is applied to the seventh switch.

In addition, the sensor capacitor is a pressure sensor capacitor or a humidity sensor capacitor, which includes a metal structure having a space for forming specific permittivity. The metal structure includes: a first metal structure having a ‘ [symbol] ’-shaped form extending horizontally in the ground direction from one point; and a second metal structure having a ‘ [symbol] ’-shaped form extending horizontally from one point and another point in the ground direction and being uniformly spaced apart from the first metal structure at a predetermined distance, wherein the first metal structure and the second metal structure respectively have protrusions protruding vertically upwards in the ground direction from the horizontally formed locations.

Moreover, the number (N) of the protrusions is N>b/(2^{a}·36.4 ppm·c·ε₀·(A/d)·1.3), wherein a is the effective number of bits of a dual quantization capacitance digital converter, b is an input capacitance area of the dual quantization capacitance digital converter, c is resolution, ε₀ is vacuum permittivity, εᵣ is relative permittivity, A is height*length, and d is a cavity width between the protrusions.

Furthermore, when the sensor capacitor is the pressure sensor capacitor, the first metal structure and the second metal structure have a comb-shaped engagement structure exposed to the air.

Additionally, the sensor capacitor is an acceleration sensor capacitor, wherein the acceleration sensor capacitor includes three or more bond wires mounted on the upper surface of a base to be spaced apart from one another. Both side ends of the right and left bond wires except the intermediate bond wire among the three bond wires are fixed on the upper surface of the base, one end of the intermediate bond wire is fixed on the upper surface of the base and the other end is separated from the base. A proof mass is attached to the other end of the intermediate bond wire.

In addition, the integrator includes an OP amp and an integrated capacitor, wherein an inverting input terminal of the OP amp is connected to an output terminal of the switch capacitor, a noninverting input terminal of the OP amp is connected to the output terminal of the switch capacitor by the medium of an eighth switch, a reference voltage terminal (V_{Com}) is connected between the eighth switch and the noninverting input terminal, the integrated capacitor is inserted between the inverting input terminal and the output terminal of the OP amp by the medium of a ninth switch, and the eighth switch is controlled by the first clock signal, and the ninth switch is controlled by the second clock signal.

Moreover, the output of the switch capacitor is transferred to the integrated capacitor of the integrator to be integrated when the first clock signal is low and the second clock signal is high, and the integrator outputs the current integration value when the first clock signal is high and the second clock signal is low.

Furthermore, the multi-bit quantizer is a 7-bit synchronous SAR-ADC.

In another aspect of the present invention, there is provided an environment information sensor circuit apparatus including: an environment information value determining unit for determining an environment information value corresponding to a sensing signal outputted from an environment information sensor circuit; and an output unit for outputting the environment information value determined by the environment information value determining unit, wherein the environment information sensor circuit includes: a switch capacitor that outputs at least one among pressure information, humidity information, and acceleration information on the basis of a first clock signal and a second clock signal that do not overlap; a single-bit 1st delta-sigma converter that includes an integrator which integrates output of the switch capacitor and outputs the integrated output as an analog value, and a single-bit quantizer which compares the output of the integrator and a preset threshold voltage with each other and outputs a single-bit digital signal corresponding to a compared result; and a multi-bit quantizer that is connected to an output terminal of the integrator by the medium of a sampling switch, and quantizes the output of the integrator at the moment the sampling switch is turned on according to a sampling signal.

### Advantageous Effects

The sensor circuit integrating standard CMOS sensors with energy efficiency and the sensor apparatus having the same according to the present invention can sense environment information of various kinds, such as pressure, humidity, acceleration, and the likes, more accurately since adopting a dual quantization capacitance digital converter structure, reduce quantization noise in low design complexity and high resolution, and operate in a wide operation area and high resolution.

Especially, the present invention can effectively reduce quantization noise without raising the degree of delta-sigma with high complexity or without using a multi-bit DAC of which resolution is not high.

The present invention can be used as a standard CMOS sensor with a new paradigm using the CMOS semiconductor not as a calculation element but as a sensing element. The present invention which is to introduce a new technology using nonideality that characteristics of the CMOS semiconductor are changed by an external environment change can obtain an effect to directly integrate the existing system semiconductors and sensing elements without using the expensive MEMS technology, bulk micromachining technology, etc.

Therefore, the present invention facilitates mass production and reduces costs remarkably since all standard CMOS sensors are integrated in one CMOS integrated chip (IC). So, the present invention can solve various problems of the conventional sensor systems that it is difficult to mass-produce sensors since the sensors in the conventional sensor systems are manufactured by various different MEMS processes and that the conventional sensor systems require high costs but provide low efficiency.

### DESCRIPTION OF DRAWINGS

FIG. 1 is a block diagram showing a structure of an environment information measuring device according to a preferred embodiment of the present invention.

FIG. 2 is a circuit conceptual diagram for explaining the basic structure of an environment information sensor circuit according to a preferred embodiment of the present invention.

FIGS. 3 to 6 are views showing that a sensor capacitor illustrated in FIG. 2 is a pressure sensor capacitor.

FIGS. 7 and 8 are views showing that the sensor capacitor illustrated in FIG. 2 is a humidity sensor capacitor.

FIG. 9 is a view showing that the sensor capacitor illustrated in FIG. 2 is an acceleration sensor capacitor.

FIG. 10 is a signal waveform graph showing a single-bit 1st delta-sigma route in the environment information sensor circuit illustrated in FIG. 2.

FIG. 11 is a signal waveform graph showing a multi-bit quantizer in the environment information sensor circuit illustrated in FIG. 2.

FIG. 12 is a circuit conceptual diagram showing a structure of an environment information sensor circuit according to another preferred embodiment of the present invention.

### MODE FOR INVENTION

The invention can be modified in various forms and can have various embodiments. Specific embodiments will be illustrated in the drawings and described in detail.

However, the embodiments are not intended to limit the invention, but it should be understood that the invention includes all modifications, equivalents, and replacements belonging to the concept and the technical scope of the invention.

The terms used in the following description are intended to merely describe specific embodiments, but not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

Not otherwise particularly defined, it will be understood that all terms used in the specification including technical or scientific terms has the same meanings as to be generally or commonly understood by those of ordinary skill in the art. It will be further understood that words or terms described as the meaning defined in commonly used dictionaries shall be interpreted as having meanings that are consistent with their meanings in the context of the relevant art and the technical idea of the invention, and shall not be interpreted as having ideal meanings or excessively formal meanings, not otherwise particularly stated.

Hereinafter, embodiments of the invention will be described in detail with reference to the accompanying drawings. In describing the invention with reference to the accompanying drawings, like elements are referenced by like reference numerals or signs regardless of the drawing numbers and description thereof is not repeated.

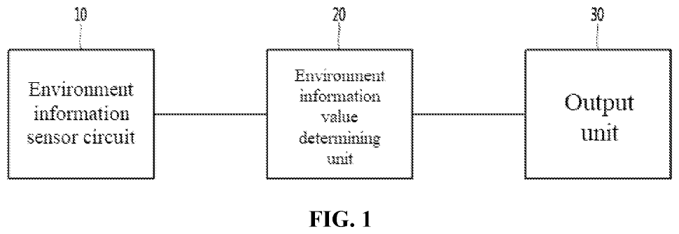

FIG. 1 is a block diagram showing a structure of an environment information measuring device according to a preferred embodiment of the present invention.

In the preferred embodiment of the present invention, environment information includes at least one of pressure information, humidity information, and acceleration information. Therefore, the environment information measuring device according to the preferred embodiment of the present invention can sense and output the environment information, for instance, at least one of the pressure information, the humidity information, and the acceleration information.

Especially, the environment information measuring device according to the preferred embodiment of the present invention can measure at least one of the pressure information, the humidity information, and the acceleration information based on a voltage output value varied according to a change in dielectric permittivity of a capacitor for measuring environment information depending on environment changes, and output the measured value to another element or device connected with the environment information measuring device.

The environment information measuring device according to the preferred embodiment of the present invention includes an environment information sensor circuit 10, an environment information value determining unit 20, and an output unit 30.

The environment information sensor circuit 10 senses a change in external environment information and outputs the sensed value.

The environment information sensor circuit 10 has a wide input capacitance range, for instance, >10 pF, and high resolution, for instance, <1fF, and includes a single-bit 1^{st} delta-sigma converter and a multi-bit quantizer in order to raise energy efficiency.

For example, the environment information sensor circuit 10 includes a pressure sensor, a humidity sensor, and an acceleration sensor.

Meanwhile, a change in capacitance by temperature and humidity is smaller than a change in capacitance by pressure. In order to realize a pressure sensor with high resolution, it is necessary to compensate temperature/humidity. Therefore, besides the pressure sensor, the humidity sensor and the acceleration sensor, an on-chip temperature sensor may be mounted additionally in order to compensate temperature/humidity using a look-up table.

The environment information value determining unit 20 determines an environment information value corresponding to a sensing signal outputted from the environment information sensor circuit 10.

The output unit 30 outputs the environment information value determined by the environment information value determining unit 20. The environment information value outputted from the output unit 30 is converted into a predetermined format and is transferred to another module for controlling environment information or is transferred to a video or audio output device to be converted and outputted into image data or voice data.

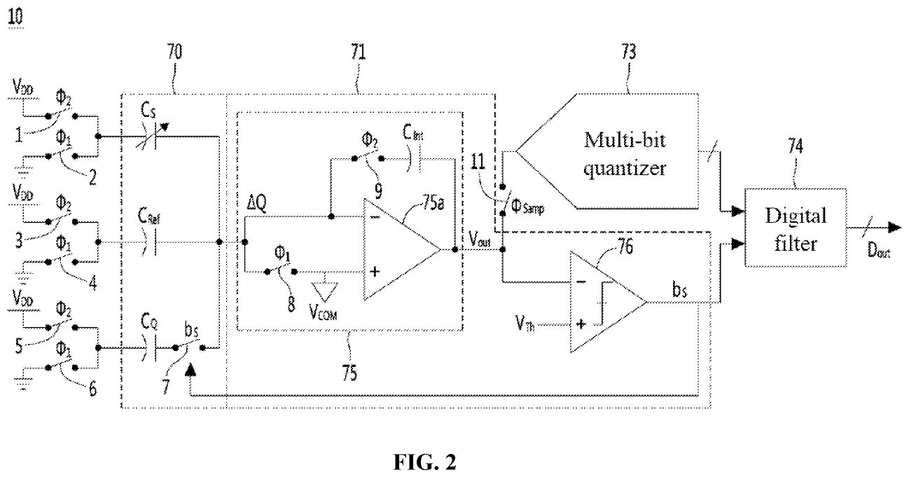

FIG. 2 is a circuit conceptual diagram for explaining the basic structure of an environment information sensor circuit according to a preferred embodiment of the present invention.

The environment information sensor circuit 10 includes a switch capacitor 70, a single-bit 1^{st} delta-sigma converter 71, a multi-bit quantizer 73, and a digital filter 74. Here, the single-bit 1^{st} delta-sigma converter 71, the multi-bit quantizer 73, and the digital filter 74 may be collectively called a dual quantization capacitance digital converter (CDC).

The switch capacitor 70 is switched by clock signals (ϕ1 and (ϕ2) that do not overlap, and outputs charges (A Q). Here, the clock signal (ϕ1) may be called a first clock signal, and the clock signal (ϕ2) may be called a second clock signal.

The switch capacitor 70 includes: a sensor capacitor (Cs) of which one end is connected to a node, wherein a first switch 1 has one end connected to a power terminal (V_{DD}) and is turned on/off by the second clock signal (ϕ2), a second switch 2 has one end connected to a ground terminal and is turned on/off by the first clock signal (ϕ1) and the other end of the first switch 1 and the other end of the second switch 2 are connected to the node; a reference voltage providing capacitor (C_{Ref}) of which one end is connected to a node, wherein a third switch 3 has one end connected to a power terminal (V_{DD}) and is turned on/off by the second clock signal (ϕ2), a fourth switch 4 has one end connected to a ground terminal and is turned on/off by the first clock signal (ϕ1) and the other end of the third switch 3 and the other end of the fourth switch 4 are connected to the node; a charge providing capacitor (C_{Q}) of which one end is connected to a node, wherein a fifth switch 5 has one end connected to a power terminal (V_{DD}) and is turned on/off by the second clock signal (ϕ2), a sixth switch 6 has one end connected to a ground terminal and is turned on/off by the first clock signal (ϕ1) and the other end of the fifth switch 5 and the other end of the sixth switch 6 are connected to the node; and a seventh switch 7 mounted between the other end of the charge providing capacitor (C_{Q}) and the output terminal and turned on/off based on a single-bit digital signal (bₛ) getting feedback from the single-bit 1^{st} delta-sigma converter 71. In this instance, the signal (bₛ) is converted into an analog signal and is applied to the seventh switch 7.

Here, the sensor capacitor (Cs), the reference voltage providing capacitor (C_{Ref}), and the charge providing capacitor (C_{Q}) are connected in parallel, and the charge providing capacitor (C_{Q}) is connected with the sensor capacitor (Cs) and the reference voltage providing capacitor (C_{Ref}) in parallel by the medium of the seventh switch 7.

That is, a charge providing capacitor unit which includes the charge providing capacitor (C_{Q}) and the seventh switch 7 may be disposed. The charge providing capacitor unit is connected in parallel with the sensor capacitor (Cs) and the reference voltage providing capacitor (C_{Ref}).

An output (ΔQ) of the switch capacitor 70 is (Cs−C_{Ref}−bₛ·C_{Q})·V_{DD}. Moreover, density (μ) of the single-bit signal (bₛ) is (Cs−C_{Ref})/C_{Q}.

In this preferred embodiment, because the environment information measuring device can measure at least one of pressure information, humidity information and acceleration information, the sensor capacitor (Cs) may be at least one among a pressure sensor, a humidity sensor and an acceleration sensor. Therefore, in FIG. 2, just one sensor capacitor (Cs) is illustrated, but a plurality of the sensor capacitors including a sensor capacitor which is a pressure sensor, a sensor capacitor which is a humidity sensor, and a sensor capacitor which is an acceleration sensor may be mounted. In this instance, a sensing signal of one selected from the pressure sensor, the humidity sensor and the acceleration sensor may be an output of the switch capacitor 70.

The single-bit 1^{st} delta-sigma converter 71 includes an integrator 75 and a single-bit quantizer 76.

The integrator 75 integrates the output of the switch capacitor 70 to generate an analog voltage signal (Vₒᵤₜ).

The integrator 75 includes an OP amp 75a and an integrated capacitor (C_{Int}). An inverting input terminal (−) of the OP amp 75a is connected to the output terminal of the switch capacitor 70, a noninverting input terminal (+) of the OP amp 75a is connected to the output terminal of the switch capacitor 70 by the medium of an eighth switch 8, and a reference voltage terminal (V_{Com}) is connected between the eighth switch 8 and the noninverting input terminal (+). The integrated capacitor (C_{Int}) is inserted between the inverting input terminal (−) and the output terminal of the OP amp 75a by the medium of a ninth switch 9. Here, the eighth switch 8 is controlled by the first clock signal (ϕ1), and the ninth switch is controlled by the second clock signal (φ2).

The output (ΔQ) of the switch capacitor 70 is integrated by the integrator 75 while moving to the integrated capacitor (C_{Int}) when the first clock signal (ϕ1) is low (“0”) and the second clock signal (φ2) is high (“1”). On the other hand, the integrator 75 outputs the current integration value (V_{Out}) when the first clock signal (ϕ1) is high (“1”) and the second clock signal (φ2) is low (“0”).

The single-bit quantizer 76 compares a preset threshold voltage (V_{Th}) with the output of the integrator 75, namely, the analog voltage signal (V_{Out}), and outputs a digital signal (bₛ) of a single-bit, namely, 1 bit, corresponding to the compared result. Here, the single-bit digital signal (bₛ) may be a pulse density modulated (PDM) signal, feeds back into the switch capacitor 70, and turns on the switch 70a.

The inverting input terminal (−) of the single-bit quantizer 76 is connected to the output terminal of the integrator 75, and the noninverting input terminal (+) is connected to a threshold voltage terminal.

The single-bit quantizer 76 guarantees linearity of the single-bit 1^{st} delta-sigma converter 71.

Therefore, the single-bit quantizer 76 can obtain output of high resolution even in a low design complexity by carrying out quantization of the most important 1-bit signal.

Moreover, quantization of the rest of bits, for instance, the remaining 7-bits of 8-bits, is carried out by the multi-bit quantizer 73 with a wide operation area and high energy efficiency, so as to enhance quantization efficiency and operational performance.

In order to enhance quantization efficiency and operational performance, the multi-bit quantizer 73 is connected to the output terminal of the integrator 75 by the medium of a sampling switch 11.

The multi-bit quantizer 73 quantizes the output, namely, the analog voltage signal (V_{Out}), of the integrator 75 at the moment the sampling switch 11 is turned on according to a sampling signal (ϕ_{Samp}). The multi-bit quantizer 73 outputs a value quantized by the remaining 7-bits from the signal from which the 1-bit signal extracted by the delta-sigma converter is deducted from 8-bit quantization signals.

The multi-bit quantizer 73, for instance, may include a SAR-ADC of a 7-bit synchronous SAR method which is switched and synchronized with the single-bit quantizer 76 based on the 1st delta-sigma converter. Here, the SAR method is a method using a successive approximation register, compares voltage sampled from an analog input signal with DAC output voltage that 1 is put only to the MSB of the SAR to determine the MSB, and repeats successive approximation up to the LSB so as to do digital signal conversion. Therefore, the present invention has high resolution and responsibility, easy multiplexer connection and can reduce quantization noise.

Preferably, the multi-bit quantizer 73 and the single-bit quantizer 76 vary output time alternately by switching synchronization.

Meanwhile, the digital filter 74 receives bitstream of the multi-bit quantizer 73 and bitstream of the single-bit quantizer 76, and can individually remove quantization noises contained in the received bitstreams according to 1-bit spectrum and 7-bit spectrum.

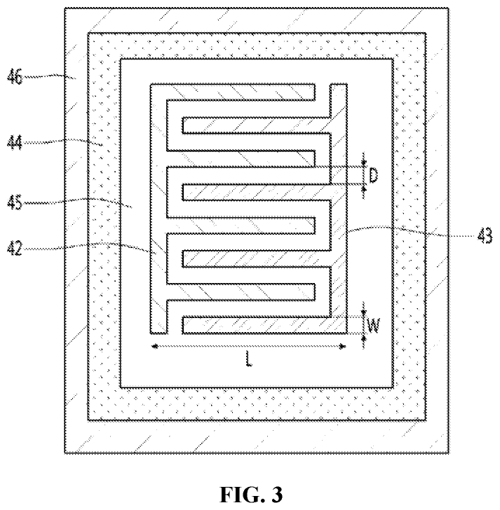

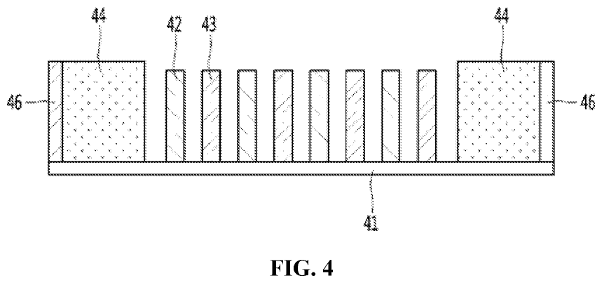

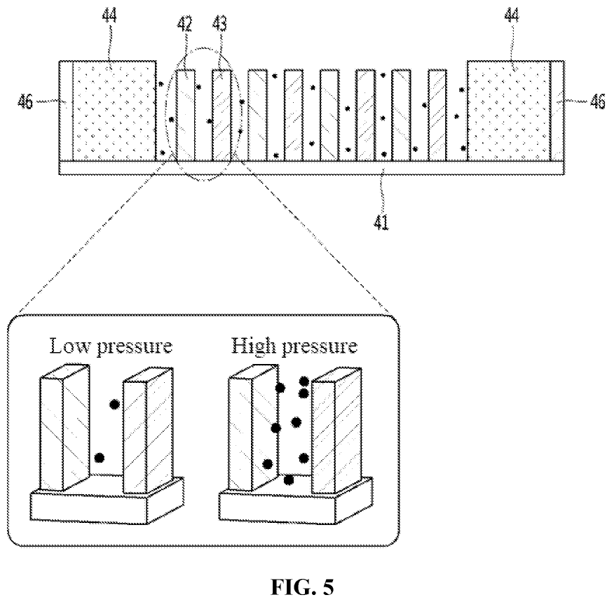

FIGS. 3 to 6 are views showing that the sensor capacitor illustrated in FIG. 2 is a pressure sensor capacitor.

The pressure sensor illustrated in FIGS. 3 to 5 includes a first metal structure 42 and a second metal structure 43 which are spaced apart from each other at the center of the upper surface of a base 41 and protrude upwards. The first metal structure 42 and the second metal structure 43 have a comb-shaped engagement structure exposed to the air. That is, the first metal structure 42 has a ‘ [symbol] ’-shaped or ‘U’-shaped form extending horizontally from one point in the ground direction, and the second metal structure 43 has a ‘ [symbol] ’-shaped or ‘U’-shaped form extending horizontally from one point and another point in the ground direction and being uniformly spaced apart from the first metal structure 42 at a predetermined distance (d). The first metal structure 42 and the second metal structure 43 are made of aluminum (Al). Aluminum can prevent corrosion caused by additional oxidation by generating Al₂O₃.

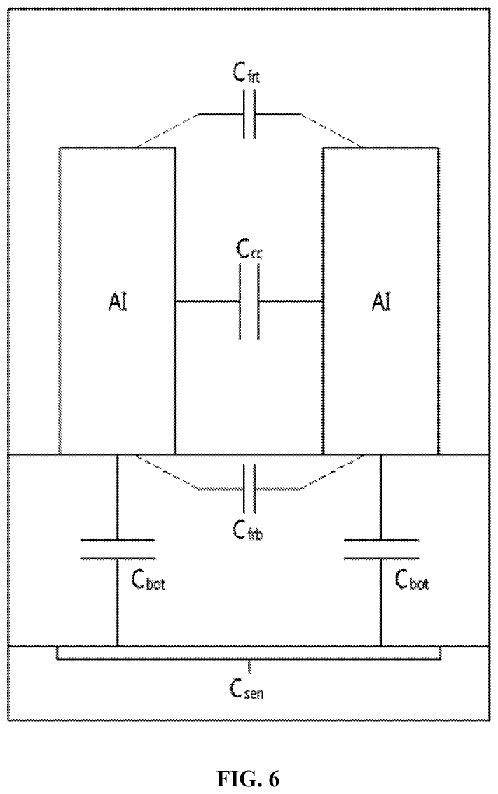

In order to maximize sensitivity per unit area, it is preferable that a distance (D) between the metal structures 42 and 43 and widths (W) of the metal structures 42 and 43 be determined to be the shortest in accordance with DRC rules. In fact, because the metal structures 42 and 43 have their widths, there are fringe capacitance (C_{frb}, C_{frt}) and bottom capacitance (C_{bot}) as shown in FIG. 6. Actually, parts contacting the air are C_{cc} and C_{frt} and occupy about 52% of the entire capacitance. In order to minimize the influence of the bottom capacitance, it is preferable to use a floating cap.

The number (N) of protrusions of the first metal structure 42 and the second metal structure 43 may be determined according to performance of the dual quantization capacitance digital converter (CDC). The first metal structure 42 and the second metal structure 43 are spaced apart from each other at the center of the upper surface of the base 41 and are mounted to protrude vertically upwards from the ground surface, and such protruding parts are called protrusions.

For instance, assuming that the effective number of bits (ENOB) of the dual quantization capacitance digital converter (CDC) is a (bits), an input capacitance area of the dual quantization capacitance digital converter (CDC) is b (pF), and resolution required for the pressure sensor is c psi, it is preferable that a range of the number (N) of the protrusions of the pressure sensor satisfy “ΔC (for c psi)=Δεᵣ·N·ε₀·(A/d)·1.3=(36.4 ppm/psi·c)·N·ε₀·(A/d)·1.3”, wherein εᵣ is relative permittivity, ε₀ is vacuum permittivity, A is height*length, and d is a cavity width between the protrusions. The pressure sensor according to the preferred embodiment of the present invention can sense only changes larger than absolute resolution of the dual quantization capacitance digital converter (CDC) (ΔC>C_{abs.res}). Therefore, N>b/(2^{a}·36.4 ppm·c·ε₀·(A/d)·1.3) must be satisfied. The entire capacitance of the pressure sensor must be smaller than the input capacitance area of the dual quantization capacitance digital converter (CDC). If a floating capacitance is used, N<b/(ε₀·(A/d)·1.75) is satisfied.

Furthermore, a passivation 44 is formed on the upper surface of the base 41 to be spaced apart from the first metal structure 42 and the second metal structure 43 and to surround the first metal structure 42 and the second metal structure 43. A guard ring 46 upwardly protrudes from the upper surface of the base 41 along the outer surface of the passivation 44. The guard ring 46 can reduce noise in the chip. The guard ring 46 may be connected to the ground (gnd).

The capacitance according to permittivity of the pressure sensor is calculated by the following mathematical formula 1.

CC=N·ε₀·εᵣ·(A/d), (Mathematical formula 1)

wherein CC is a capacitance (F), N is the number of the protrusions protruding from both metal structures, ε₀ is vacuum permittivity, εᵣ is relative permittivity, A is height*length, and d is a cavity width between the protrusions.

Therefore, permittivity of the air around the pressure sensor may be varied according to pressure.

The passivation of the pressure sensor according to the preferred embodiment of the present invention was removed by a pad-open layer (standard process) so that the first metal structure 42 and the second metal structure 43 can contact the air. In FIG. 3, the unexplained reference numeral 45 is the pad-open layer.

The pressure sensor according to the preferred embodiment of the present invention uses a change in dielectric constant caused by atmospheric pressure of about 34 ppm/psi. The pressure sensor according to the preferred embodiment of the present invention can accept a pressure range of more than 5 atmospheres. Additionally, the pressure sensor according to the preferred embodiment of the present invention is more advantageous in mass production than the conventional MEMS and can reduce the price remarkably since using the standard CMOS process.

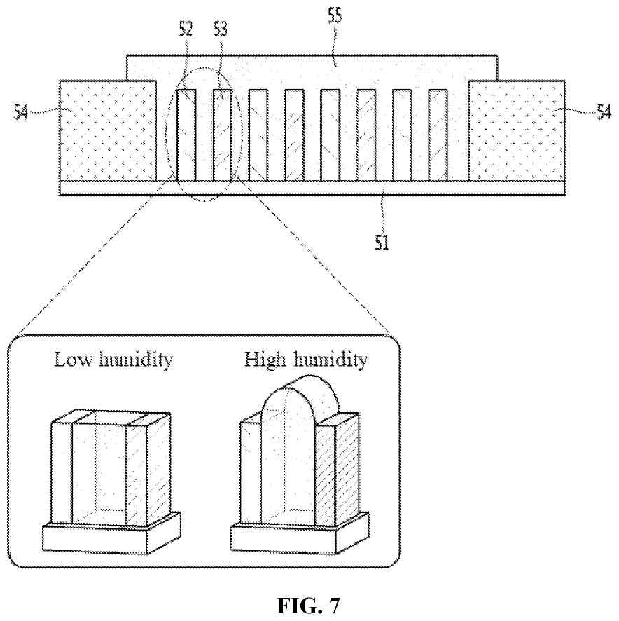

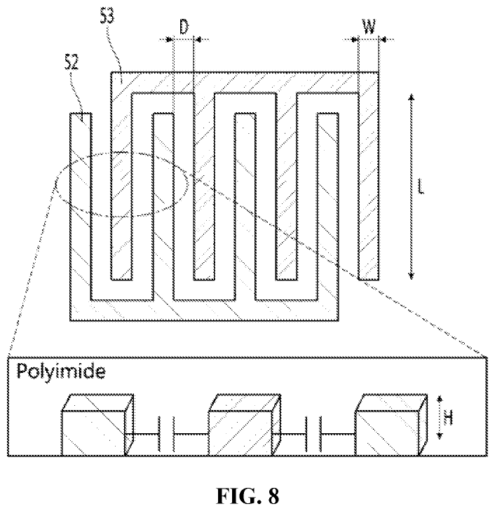

FIGS. 7 and 8 are views showing that the sensor capacitor illustrated in FIG. 2 is a humidity sensor capacitor.

The humidity sensor illustrated in FIGS. 7 and 8 includes a ‘ [symbol] ’-shaped first metal structure 52 continuously formed from one point, and a ‘ [symbol] ’-shaped or ‘U’-shaped second metal structure 53 continued from one point and another point of the first metal structure 52 and spaced apart from the first metal structure 52 at a predetermined distance (d). That is, the first metal structure 52 and the second metal structure 53 are mounted at the center of the upper surface of a base 51, and are formed in a comb-shape.

A passivation 54 is formed on the upper surface of the base 51 to be spaced apart from the first metal structure 52 and the second metal structure 53 and to surround the first metal structure 52 and the second metal structure 53.

In addition, the first metal structure 52 and the second metal structure 53 are covered with polyimide 55 of which permittivity is changed due to expansion by moisture. A polyimide layer may be used in the CMOS process which has been widely used in flip-chip packaging of the passivation.

The humidity sensor can sense humidity using a change in relative permittivity of the polyimide 55. The relative permittivity (e) of the polyimide 55 is calculated by the following mathematical formula 2.

$$e = {( γ ( \sqrt[3]{{e}_{w}} - \sqrt[3]{{e}_{p}} ) + \sqrt[3]{{e}_{p}} )}^{3} , \qquad ( Mathematical formula 2 )$$

wherein r is a volume of water of a polyimide film, e_{w} is permittivity of water, and eₚ is permittivity of polyimide.

Therefore, the capacitance according to permittivity of the humidity sensor is calculated by the above mathematical formula 1.

The number (N) of protrusions of the first metal structure 52 and the second metal structure 53 may be determined according to performance of the dual quantization capacitance digital converter (CDC). The first metal structure 52 and the second metal structure 53 are mounted at the center of the upper surface of the base 51 to protrude upwards and to be spaced apart from each other, and such protruding parts are called protrusions. For instance, assuming that the effective number of bits (ENOB) of the dual quantization capacitance digital converter (CDC) is a (bits), an input capacitance area of the dual quantization capacitance digital converter (CDC) is b (pF), and resolution required for the humidity sensor is c psi, it is preferable that a range of the number (N) of the protrusions of the humidity sensor satisfy “ΔC (for c psi)=Δεᵣ·N·ε₀·1.3=(36.4 ppm/psi·c)·N·ε₀·(A/d)·1.3”, wherein εᵣ is relative permittivity, ε₀ is vacuum permittivity, A is height*length, and d is a cavity width between the protrusions. The humidity sensor according to the preferred embodiment of the present invention can sense only changes larger than absolute resolution of the dual quantization capacitance digital converter (CDC) (ΔC>C_{abs.res}). Therefore, N>b/(2^{a}·36.4 ppm·c·ε₀·(A/d)·1.3) must be satisfied. The entire capacitance of the humidity sensor must be smaller than the input capacitance area of the dual quantization capacitance digital converter (CDC). If a floating capacitance is used, N<b/(ε₀·(A/d)·1.75) is satisfied.

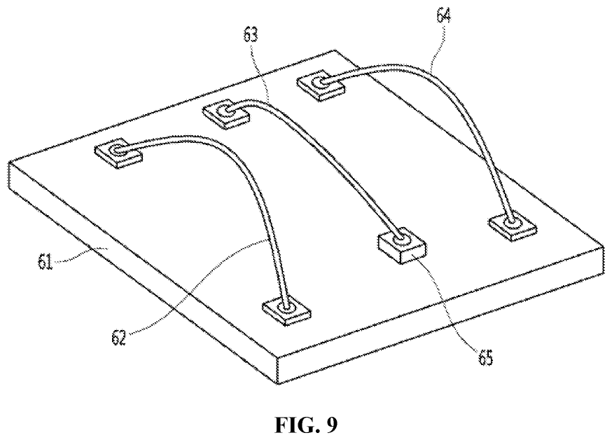

FIG. 9 is a view showing that the sensor capacitor illustrated in FIG. 2 is an acceleration sensor capacitor.

The acceleration sensor illustrated in FIG. 9 is realized by three bond wires 62, 63 and 64. That is, the three bond wires 62, 63 and 64 are mounted on the upper surface of a base 61, which may be called a pad, to be spaced apart from one another.

Here, both side ends of the right and left bond wires 62 and 64 except the intermediate bond wire 63 among the three bond wires 62 to 64 are fixed and connected to the upper surface of the base 61. Moreover, one end of the intermediate bond wire 63 is fixed and connected to the upper surface of the base 61 and the other end is separated from the base 61, and a proof mass 65 of a predetermined size is attached to the place where the other end of the intermediate bond wire is separated.

The acceleration sensor can maximize the change in capacitance by acceleration since additionally having the proof mass 65.

Meanwhile, sensitivity is increased as the dimension of the proof mass 65 is increased, but a measurable acceleration range is reduced. Therefore, the dimension of the proof mass 65 must be determined in consideration of sensitivity and the measurable acceleration range.

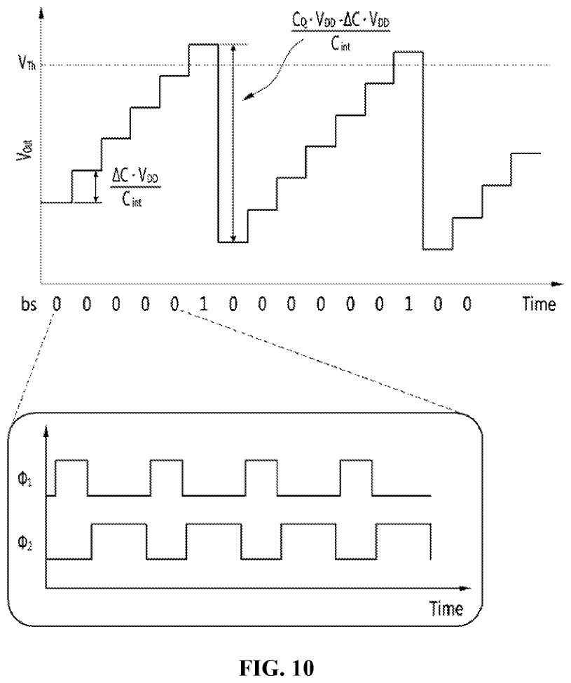

FIG. 10 is a signal waveform graph showing a single-bit 1st delta-sigma route in the environment information sensor circuit illustrated in FIG. 2.

The single-bit 1^{st} delta-sigma route is formed by the switch capacitor 70 and the single-bit 1^{st} delta-sigma converter 71 in the environment information sensor 10 of FIG. 2. In order to understand the signal waveform graph of FIG. 10, you must see the single-bit 1^{st} delta-sigma route of FIG. 2.

In FIG. 10, the first and second clock signals (ϕ1 and ϕ2) which are non-overlapping signals.

The output (ΔQ) of the switch capacitor 70 is integrated to the integrated capacitor (C_{Int}) when the first clock signal (ϕ1) is low (“0”) and the second clock signal (φ2) is high (“1”). Here, the output (ΔQ) of the switch capacitor 70 includes capacitance of the sensor capacitor (Cs), for instance, a value corresponding to any one among pressure information, humidity information, and acceleration information.

On the other hand, the integrator 75 outputs the current integration value (V_{Out}) when the first clock signal (ϕ1) is high (“1”) and the second clock signal (φ2) is low (“0”).

Therefore, the single-bit quantizer 76 comparatively calculates the output (V_{Out}) of the integrator 75 and the preset threshold voltage (V_{Th}), and outputs the comparatively calculated value as a single-bit (namely, 1-bit) digital signal (bₛ) through analog-digital conversion. Here, the single-bit (namely, 1-bit) digital signal (bₛ) may be a pulse density modulated (PDM) signal.

For instance, the single-bit quantizer 76 can output the single-bit digital signal (bₛ) which is low (“0”) if the output (V_{Out}) of the integrator 75 is below the threshold voltage (V_{Th}). On the other hand, the single-bit quantizer 76 can output the single-bit digital signal (bₛ) which is high (“1”) if the output (V_{Out}) of the integrator 75 is more than the threshold voltage (V_{Th}).

Furthermore, the single-bit digital signal (bₛ) outputted from the single-bit quantizer 76 is applied to the digital filter 74 and feeds back into the switch capacitor 70. Here, the single-bit digital signal (bₛ) feeding back into the switch capacitor 70 will be a control signal to turn on/off the seventh switch 7 of the switch capacitor 70. That is, the single-bit digital signal (bₛ) will be converted into an analog signal and applied to the seventh switch 7.

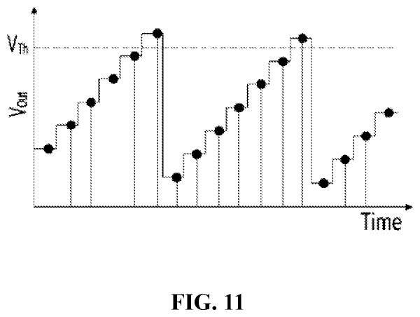

FIG. 11 is a signal waveform graph showing a multi-bit quantizer in the environment information sensor circuit illustrated in FIG. 2.

Referring to FIG. 11, the multi-bit quantizer 73 samples and quantizes the output (V_{Out}), namely, the analog voltage signal, of the integrator 75 whenever the sampling switch 11 is turned on according to a periodic sampling signal (ϕSₐₘₚ).

In other words, the multi-bit quantizer 73 may be a 7-bit synchronous SAR-ADC. The multi-bit quantizer 73 samples (S&H) the output (V_{Out}) of the integrator 75 whenever the sampling switch 11 is turned on according to a periodic sampling signal (ϕSₐₘₚ). After that, 1 is put into the MSB of the SAR, and then, a digital value of the SAR is converted into an analog value (V_{Th}) through digital-analog conversion.

After that, the sampled voltage and the analog value (V_{Th}) are compared with each other in size. For instance, if the sampled voltage is more than the analog value (V_{Th}), the MSB is determined as “1”, but if the sampled voltage is less than the analog value (V_{Th}), the MSB is determined as “0”. As described above, the same successive approximation is repeated up to the LSB till the conversion into a desirable-bit digital signal is completed.

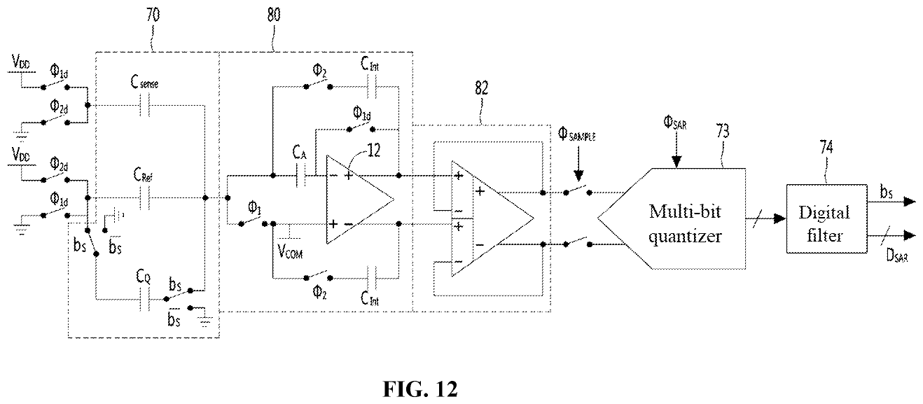

FIG. 12 is a circuit conceptual diagram showing a structure of an environment information sensor circuit according to another preferred embodiment of the present invention.

The environment information sensor circuit of FIG. 12 and the environment information sensor circuit of FIG. 2 have the same reference numerals in relation with the same components.

Compared with the integrator 75 of FIG. 2, there is a difference in that an integrator 80 of FIG. 12 adopts autozeroing. The integrator 80 of FIG. 12 can remove offset and flicker noise of the OP amp since adopting the autozeroing. The OP amp of the integrator 80 of FIG. 12 may be a folded-cascade amplifier.

Furthermore, compared with the environment information sensor circuit of FIG. 2, there is a difference in that the environment information sensor circuit of FIG. 12 additionally has a fully differential difference amplifier (FDDA) 82 between the integrator 80 and the multi-bit quantizer 73. The FDDA 82 can restrain kickback noise and common-mode noise from the multi-bit quantizer 73.

Additionally, in FIG. 12, the environment information sensor circuit can reduce power consumption since sharing the multi-bit quantizer 73 with the single-bit quantizer.

That is, the environment information sensor circuit of FIG. 12 may be a capacitance digital converter (CDC) in which a single-bit 1^{st} delta-sigma converter based on the switch capacitor (SC) and a synchronous SAR-ADC with energy efficiency are combined with each other.

As described above, the optimum embodiment is disclosed in the drawings and specification. Here, specific terms are used, but the specific terms are used to describe the present invention but are not to limit the meanings or to limit the scope of the present invention described in claims. Therefore, it may be appreciated that those skilled in the art can change or modify the embodiments from the above description in various ways. Accordingly, the actual technical protection scope of the present invention must be determined by the spirit of the appended claims.

### EXPLANATION OF REFERENCE NUMERALS

10: environment information sensor circuit
20: environment information value determining unit
30: output unit
70: switch capacitor
71: single-bit 1^{st} delta-sigma converter
73: multi-bit quantizer
74: digital filter
75: integrator
76: single-bit quantizer

1. An environment information sensor circuit for sensing environment information, which includes at least one among pressure information, humidity information and acceleration information, the environment information sensor circuit comprising:
a switch capacitor that outputs at least one among pressure information, humidity information, and acceleration information on the basis of a first clock signal and a second clock signal that do not overlap;
a single-bit 1^{st} delta-sigma converter that includes an integrator which integrates output of the switch capacitor and outputs the integrated output as an analog value, and a single-bit quantizer which compares the output of the integrator and a preset threshold voltage with each other and outputs a single-bit digital signal corresponding to a compared result; and
a multi-bit quantizer that is connected to an output terminal of the integrator by the medium of a sampling switch, and quantizes the output of the integrator at the moment the sampling switch is turned on according to a sampling signal.

2. The environment information sensor circuit according to claim 1, wherein the switch capacitor comprises:
a sensor capacitor of which one end is connected to a node, wherein a first switch has one end connected to a power terminal and is turned on/off by the second clock signal, a second switch has one end connected to a ground terminal and is turned on/off by the first clock signal and the other end of the first switch and the other end of the second switch are connected to the node;
a reference voltage providing capacitor of which one end is connected to a node, wherein a third switch has one end connected to a power terminal and is turned on/off by the second clock signal, a fourth switch has one end connected to a ground terminal and is turned on/off by the first clock signal and the other end of the third switch and the other end of the fourth switch are connected to the node;
a charge providing capacitor of which one end is connected to a node, wherein a fifth switch has one end connected to a power terminal and is turned on/off by the second clock signal, a sixth switch has one end connected to a ground terminal and is turned on/off by the first clock signal and the other end of the fifth switch and the other end of the sixth switch are connected to the node; and
a seventh switch mounted between the other end of the charge providing capacitor and the output terminal and turned on/off based on a single-bit digital signal getting feedback from the single-bit 1^{st} delta-sigma converter.

3. The environment information sensor circuit according to claim 1, wherein the charge providing capacitor unit which includes the charge providing capacitor and the seventh switch is connected in parallel with the sensor capacitor and the reference voltage providing capacitor.

4. The environment information sensor circuit according to claim 1, wherein the single-bit digital signal is converted into an analog signal and is applied to the seventh switch.

5. The environment information sensor circuit according to claim 2, wherein the sensor capacitor is a pressure sensor capacitor or a humidity sensor capacitor, which includes a metal structure having a space for forming specific permittivity,
wherein the metal structure includes:
a first metal structure having a ‘ [symbol] ’-shaped form extending horizontally in the ground direction from one point; and
a second metal structure having a ‘ [symbol] ’-shaped form extending horizontally from one point and another point in the ground direction and being uniformly spaced apart from the first metal structure at a predetermined distance, and
wherein the first metal structure and the second metal structure respectively have protrusions protruding vertically upwards in the ground direction from the horizontally formed locations.

6. The environment information sensor circuit according to claim 5, wherein the number (N) of the protrusions is N>b/2^{a}·36.4 ppm·c·ε₀·(A/d)·1.3), wherein a is the effective number of bits of a dual quantization capacitance digital converter, b is an input capacitance area of the dual quantization capacitance digital converter, c is resolution, ε₀ is vacuum permittivity, εᵣ is relative permittivity, A is height*length, and d is a cavity width between the protrusions.

7. The environment information sensor circuit according to claim 5, wherein when the sensor capacitor is the pressure sensor capacitor, the first metal structure and the second metal structure have a comb-shaped engagement structure exposed to the air.

8. The environment information sensor circuit according to claim 2, wherein the sensor capacitor is an acceleration sensor capacitor,
wherein the acceleration sensor capacitor includes three or more bond wires mounted on the upper surface of a base to be spaced apart from one another,
wherein both side ends of the right and left bond wires except the intermediate bond wire among the three bond wires are fixed on the upper surface of the base, one end of the intermediate bond wire is fixed on the upper surface of the base and the other end is separated from the base, and
wherein a proof mass is attached to the other end of the intermediate bond wire.

9. The environment information sensor circuit according to claim 1, wherein the integrator includes an OP amp and an integrated capacitor,
wherein an inverting input terminal of the OP amp is connected to an output terminal of the switch capacitor, a noninverting input terminal of the OP amp is connected to the output terminal of the switch capacitor by the medium of an eighth switch,
wherein a reference voltage terminal (V_{Com}) is connected between the eighth switch and the noninverting input terminal,
wherein the integrated capacitor is inserted between the inverting input terminal and the output terminal of the OP amp by the medium of a ninth switch, and
wherein the eighth switch is controlled by the first clock signal, and the ninth switch is controlled by the second clock signal.

10. The environment information sensor circuit according to claim 9, wherein the output of the switch capacitor is cascade transferred to the integrated capacitor of the integrator to be integrated when the first clock signal is low and the second clock signal is high, and
Wherein the integrator outputs the current integration value when the first clock signal is high and the second clock signal is low.

11. The environment information sensor circuit according to claim 1, wherein the multi-bit quantizer is a 7-bit synchronous successive approximation register-based analog-digital converter (SAR-ADC).

12. An environment information sensor circuit apparatus comprising:
an environment information value determining unit for determining an environment information value corresponding to a sensing signal outputted from an environment information sensor circuit; and
an output unit for outputting the environment information value determined by the environment information value determining unit,
wherein the environment information sensor circuit comprises:
a switch capacitor that outputs at least one among pressure information, humidity information, and acceleration information on the basis of a first clock signal and a second clock signal that do not overlap;
a single-bit 1^{st} delta-sigma converter that includes an integrator which integrates output of the switch capacitor and outputs the integrated output as an analog value, and a single-bit quantizer which compares the output of the integrator and a preset threshold voltage with each other and outputs a single-bit digital signal corresponding to a compared result; and
a multi-bit quantizer that is connected to an output terminal of the integrator by the medium of a sampling switch, and quantizes the output of the integrator at the moment the sampling switch is turned on according to a sampling signal.
